(19) United States
(12) Patent Application Publication
(10) Pub. No.: US 2013/0016079 A1
(43) Pub. Date: Jan. 17, 2013

(54) REFLECTIVE DISPLAY DEVICE WITH AUXILIARY DISPLAY

(71) Applicants: CHUNG-WEI WANG, Tu-Cheng (TW); CHIU-HSIUNG LIN, Tu-Cheng (TW); KUAN-HONG HSIEH, Tu-Cheng (TW)

(72) Inventors: CHUNG-WEI WANG, Tu-Cheng (TW); CHIU-HSIUNG LIN, Tu-Cheng (TW); KUAN-HONG HSIEH, Tu-Cheng (TW)

(73) Assignee: HON HAI PRECISION INDUSTRY CO., LTD., Tu-Cheng (TW)

(21) Appl. No.: 13/329,331

(22) Filed: Dec. 19, 2011

(30) Foreign Application Priority Data
Jul. 14, 2011 (TW) 100125022

(51) Int. Cl. G09G 5/10

(52) U.S. Cl. 345/207

(57) ABSTRACT

A reflective display device includes a housing, a reflective display unit, an auxiliary display unit, a power supply, a wireless transceiver, a lighting unit, a light sensing unit, a light source control module, an identifying module, and a display control module. The power supply supplies power to the reflective display device and converts ambient light into electrical power and stores the electrical power. The wireless transceiver receives information transmitted from the electronic device. The lighting unit is fixed to the housing and illuminates the reflective display unit. The light sensing unit detects brightness of ambient light. The light source control module turns on/off the lighting unit. The identifying module identifies the type of the information. The display control module selectively controls the information to be displayed on the reflective display or the auxiliary display unit according to the type of the information.

### BACKGROUND

1. Technical Field

The present disclosure relates to display devices with reflective displays, and particularly, to a reflective display device having an auxiliary display for displaying real-time information.

2. Description of Related Art

Display devices are widely used outdoors and indoors for advertising, guiding, warning, etc. Some of the display devices employ reflective displays and solar battery for saving power. However, the reflective displays depend on ambient light and cannot clearly display in weak ambient light conditions (e.g., at night).

Therefore, what is needed is a reflective display device with an auxiliary display that can overcome the limitations described above.

### BRIEF DESCRIPTION OF THE DRAWINGS

The components in the drawings are not necessarily drawn to scale, the emphasis instead being placed upon clearly illustrating the principles of a reflective display device with an auxiliary display. Moreover, in the drawings, like reference numerals designate corresponding sections throughout the several views.

FIG. 1 is a block diagram of a reflective display device in accordance with an exemplary embodiment.

FIG. 2 is a schematic view of the reflective display device of FIG. 1.

FIG. 3 is a schematic view of the reflective display device of FIG. 1, in accordance with another exemplary embodiment.

### DETAILED DESCRIPTION

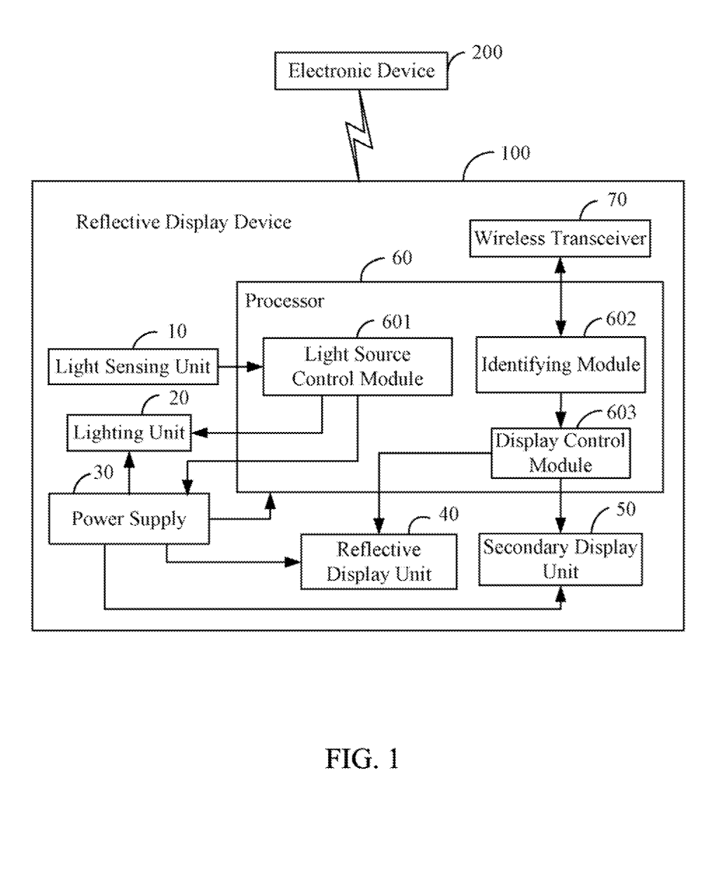

Referring to FIG. 1, a reflective display device 100 is disclosed as an exemplary embodiment. The display device 100 includes a light sensing unit 10, a lighting unit 20, a power supply 30, a reflective display unit 40, a secondary display unit 50, a processor 60, and a wireless transceiver 70.

The light sensing unit 10 is used to detect the brightness of the ambience light, and to convert the detected brightness into electrical signals. In this embodiment, the light sensing unit 10 is a light sensor.

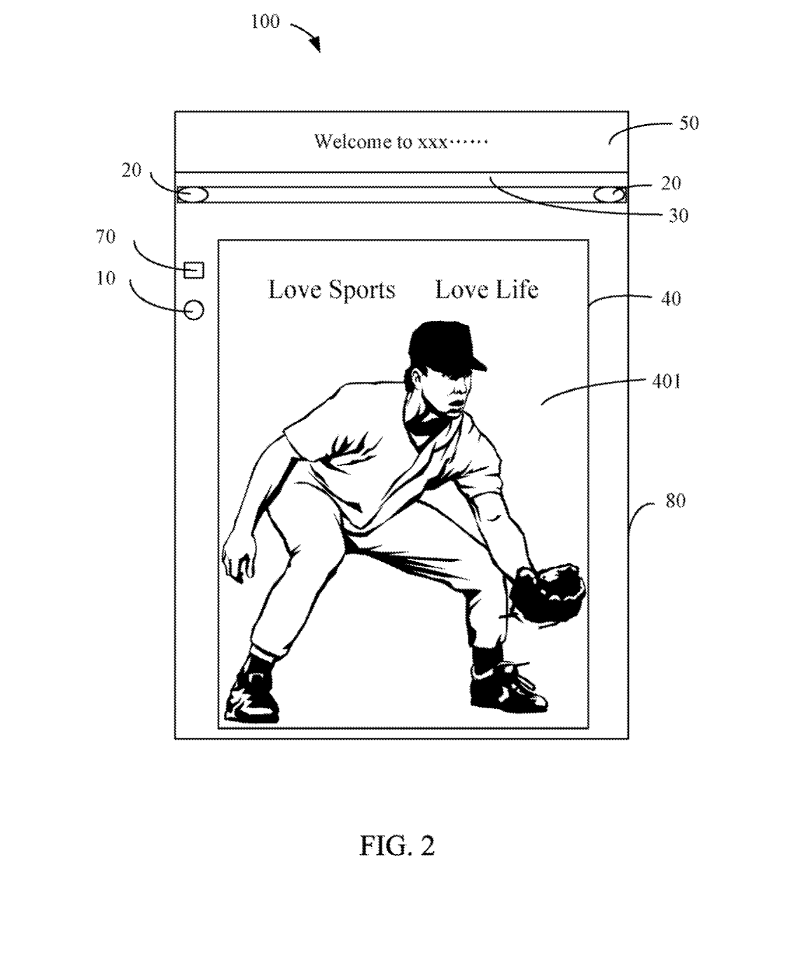

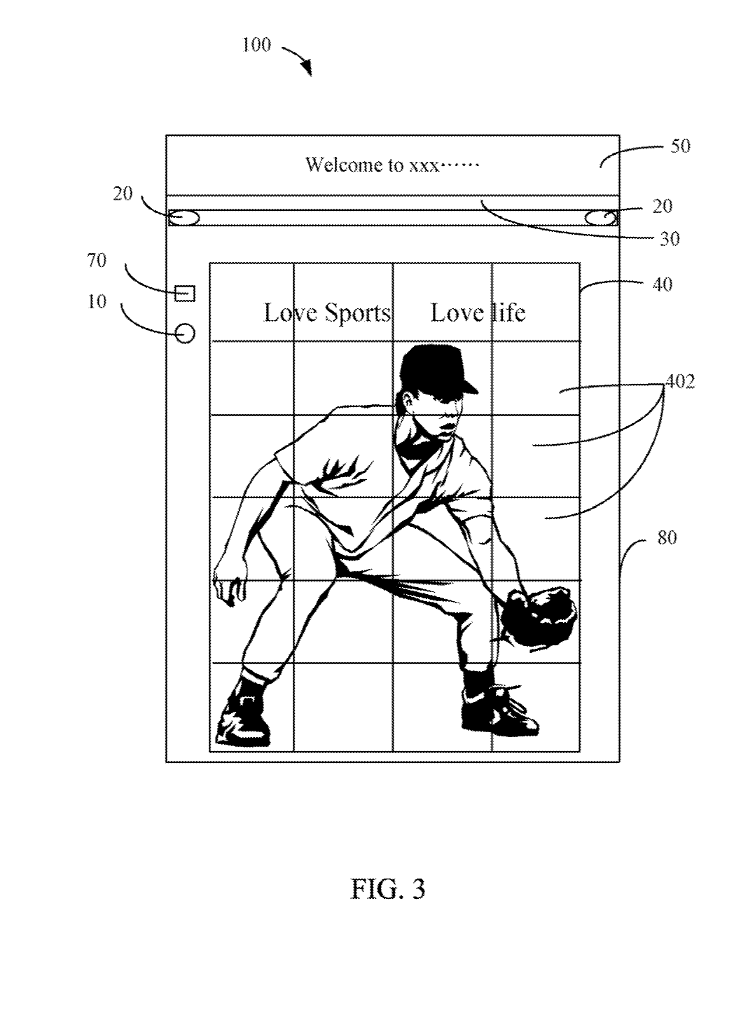

The lighting unit 20 is fixed on the display device 100 to illuminate the reflective display unit 40. Referring to FIGS. 2 and 3, the lighting unit 20 includes two down lighting lamps arranged above the reflective display unit 40 thus to illuminate the reflective display 40 when needed. The down lighting lamps can be light emitting diode (LED) lamps, cold-cathode fluorescent lamps (CCFLs), fluorescent lamps, or the like. In another embodiment, the lighting unit 20 includes one or more front lighting lamp(s), as long as the lighting unit 20 can illuminate the electronic paper display 40. The lighting unit 20 can provide sufficient light for the reflective display 40, thus allowing the reflective display 40 to operate in weak ambient light conditions (e.g., at night).

Referring back to FIG. 1, the power supply 30 is used to supply power to the display device 100. In the embodiment, the power supply can convert light energy into electrical power, and thus saves the electrical power. In the embodiment, the power supply 30 converts light energy into electrical power, and saves the electrical power, only when the brightness of the ambient light is higher than a predetermined value. The power supply 30 includes a rechargeable solar battery to store the electrical power converted from the light energy. Thus, the display device 100 is energy efficient and environmentally friendly.

The reflective display 40 can be electrophoretic type, cholesterol LCD type, electro-wetting type, electrochromic type, or micro-electro-mechanical type. The reflective display unit 40 has the advantage of low power consumption, and can display information for a long time after the power supply 30 is cut off.

In one embodiment, as shown in FIG. 2, the reflective display unit 40 includes only one display unit. In an alternative embodiment, the reflective display unit 40 may include a number of display units 402 as shown in FIG. 3. The display units 402 are joined together in a matrix manner to form the reflective display unit 40. With such a configuration, the size of the display device 100 can be adjusted according to actual need by increasing or reducing the number of the display units 402. For example, the display units 402 can be used as an advertising board and has a size about 400 mm in width and 600 mm in length.

The secondary display unit 50 can be an LCD or LED display with single or multi-colors.

The wireless transceiver 70 can communicate with an electronic device 200 within a preset distance away from the display device 100, and can receive information from the electronic device 200. The electronic device 200 can be a computer. The wireless transceiver 70 communicates with the electronic device 200 via WIFI, RF, BLUETOOTH, or other wireless manners.

In the embodiment, the information to be displayed sent by the electronic device 200 includes an information identification (hereinafter ID), based on which type of the information can be identified. There are two types of information, real-time type information and the stable type information. The real-time type information represents real-time message which needs to effectively attract the attention of viewers. The real-time type information occupies less memory than the stable type information and usually includes characters, numerals, etc. The stable type of information represents information such as advertising, guiding etc., and usually includes characters, figures, pictures, photos, etc. In this embodiment, the stable type information is displayed in a static manner. The real-time information is displayed in a dynamic manner. For example, the real-time information could be a text or an image periodically moving in a given direction on the display unit. In an alternative embodiment, the display device 100 can identify types of the information to be displayed by respectively transmitting different type information in different frequencies. For example, the real-time type information is updated with a frequency of 3.5 GHz, and the stable type information is updated with a frequency between 1.5 GHz to 3.5 GHz.

The processor 60 includes a light source control module 601, an identifying module 602, and a display control module 603.

The light source control module 601 is used to turn on/off the lighting unit 20 according to the brightness value of the ambient light detected by the light sensing unit 10. In this embodiment, when the brightness value of the ambient light is lower than a first predetermined value, the light source control module 601 turns on the lighting unit 20 to illuminate the reflective display unit 40.

The light source control module 601 is further used to transmit control signals to the power supply 30 corresponding to the brightness of the ambient light detected by the light sensing unit 10. The power supply 30 can then start or stop generating electrical power according to the brightness of the ambient light. In the embodiment, if the brightness value of the ambient light exceeds a second predetermined value, the light source control module 601 transmits a start signal to the power supply 30, to control the power supply 30 to generate electrical power utilizing the ambient light. If the brightness value of the ambient light does not exceed the second predetermined value, the light source control module 601 transmits a stop signal to the power supply 30, to control the power supply 30 to stop generating. The power supply 30 keeps supplying power to the display device 100 to maintain the work of the display device 100 as long as the electrical power storing therein exceeds a predetermined level.

The identifying module 602 is used to identify the type of the information received by the wireless transceiver 70 according to the information ID. In an alternative embodiment, the identifying module 602 may identify the type of the information according to the transmitting frequencies of the information. The identifying module 602 further transmits the identifying results and the information to the display control module 603.

The display control module 603 is used to selectively control the information received by the wireless transceiver 70 to be displayed on the electronic paper display 40 or the secondary display unit 50 according to the type of the information. In the embodiment, the real-time type information is controlled to be displayed on the secondary display unit 50, and the stable type information is controlled to be displayed on the electronic paper display 40.

Referring again to FIG. 3, when the reflective display unit 40 includes a number of display units 402, the display control module 603 is further used to distribute the stable type information on the display units 402, so that the display units 402 corporately display a whole image corresponding to the stable type information.

Referring again to FIGS. 2 and 3, the display device 100 further includes a housing 80. The housing 80 is configured for enclosing the display device 100. In this embodiment, the housing 80 is made of flexible plastic materials, rubber or the like. The reflective display unit 40 can also be bendable and made of flexible materials. And the other components of the display device 100 can be flexible. As such, the display device 100 can be carried along anywhere the user goes, and can be fixed or stacked on a smooth or curve surface. In another embodiment, the housing 80 is an inflexible substrate, such as a substrate that is made up of glass, metal, or the like.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A reflective display device comprising:
a housing;
a reflective display unit;
an auxiliary display unit;
a power supply configured to supply power to the reflective display device and capable of converting ambient light into electrical power and storing the electrical power;
a wireless transceiver configured to wirelessly communicate with an electronic device, and to receive information transmitted from the electronic device;
a lighting unit fixed to the housing and configured to illuminate the reflective display unit;
a light sensing unit, configured to detect brightness of ambient light and to convert the detected brightness into electrical signals;
a light source control module configured to turn on or turn off the lighting unit according to the brightness of the ambient light;
an identifying module configured to identify the type of the information received by the wireless transceiver; and
a display control module configured to selectively control the information received by the wireless transceiver to be displayed on the reflective display or the auxiliary display unit according to the type of the information.

2. The reflective display device as described in claim 1, wherein the information is selected from the group consisting of real-time type information and stable type information.

3. The reflective display device as described in claim 2, wherein the information comprises an information ID, and the identifying module identifies the type of the information according to the information ID.

4. The reflective display device as described in claim 2, wherein the display control module controls the auxiliary display unit to display the real-time type information in a dynamic manner, and controls the reflective display unit to display the stable type information in a static manner.

5. The reflective display device as described in claim 1, wherein the light source control module is further configured to transmit control signals associated with the brightness of the ambient light to the power supply to control the power supply start or stop generating the electrical power according to the brightness of the ambient light.

6. The reflective display device as described in claim 1, wherein the lighting unit is selected from the group consisting of an LED lamp, a CCFL lamp, and a fluorescent lamp.

7. The display device as described in claim 1, wherein the auxiliary display unit is an LCD or LED display.

8. The reflective display device as described in claim 1, wherein the auxiliary display unit has single color or multi-colors.

9. The reflective display device as described in claim 1, wherein the reflective display unit is selected from the group consisting of an electrophoretic display, a cholesterol LCD display, an electro-wetting display, an electrochromic display, and a micro-electro-mechanical display.

10. The reflective display device as described in claim 1, wherein the housing is bendable and made of flexible material.
